(19) United States
(12) Patent Application Publication
(10) Pub. No.: US 2016/0282502 A1
(43) Pub. Date: Sep. 29, 2016

(54) FRACTURE DIAGNOSIS USING ELECTROMAGNETIC METHODS

(71) Applicant: BOARD OF REGENTS, THE UNIVERSITY OF TEXAS SYSTEM, Austin, TX (US)

(72) Inventors: Mukul M. Sharma, Austin, TX (US); Saptaswa Basu, Houston, TX (US)

(21) Appl. No.: 15/035,097

(22) PCT Filed: Nov. 4, 2014
(86) PCT No.: PCT/US14/63866

§ 371 Date: May 6, 2016

Related U.S. Application Data
(60) Provisional application No. 61/901,863, filed on Nov. 8, 2013.

(51) Int. Cl. G01V 3/30; G01V 99/00; G01V 3/38

(52) U.S. Cl. CPC G01V 3/30; G01V 3/38; G01V 99/005

(57) ABSTRACT

Disclosed herein is a method for fracture diagnostics by the use of electromagnetic transmitters and receivers in or near the borehole and an electrically conductive proppant. Injecting an electrically conductive proppant into a hydraulic fracture transforms it into highly conductive fractured volume in a rock medium of relatively low electrical conductivity. The highly conductive fracture can be easily separated from the background rock matrix due to the large electrical conductivity difference. The fracture can be excited through electromagnetic radiation by use of (a) transmitting antenna(s) in, above or immediately outside the borehole and will then be able to communicate with (a) receiver antenna(s) in, above or immediately outside the borehole. Using the principles of electromagnetism to analyze the simulated communication patterns between the fractured antenna transmitters and receivers, the length, height and orientation of the hydraulic fracture may be determined.

### BACKGROUND OF THE INVENTION

1. Field of the Invention

The invention generally relates to analysis of geological formations. More particularly, the invention relates to the analysis of underground fractured volumes.

2. Description of the Relevant Art

Hydraulic fracturing has become a major driver of oil and gas production in United States. Knowledge of hydraulic fracture dimensions is of great importance when it comes to predicting production and for validating reservoir and fracture models. This knowledge is used to improving production economics. However, a cheap, direct and repeatable post-fracturing diagnostic tool to measure the dimensions and orientation of hydraulic fractures, particularly propped fracture dimensions is not presently available. While many fracture diagnostic tools and methods are available, most suffer from significant deficiencies and/or are very expensive to implement.

There are primarily two current methods for fracture diagnostics: tracers and microseismic monitoring. Tracers have the limitation that they can only provide information about the fracture a few inches away from the borehole or where the fracture is intersecting the borehole. Microseismic monitoring measures the created fracture dimensions, but not the propped fracture length, since this method only measures the location of shear failure events, while the propped fracture is almost always created by tensile failure. Microseismic monitoring is also very expensive requiring the use of down-hole geophones and surface monitoring equipment. Thus, microseismic monitoring fails to provide the information that is of the most interest to operators: the propped fracture length and orientation. These two parameters have a first order impact on production.

Thus, it is desirable to have new techniques for determining the physical properties of underground fractured volumes that allow the determination of the length, height and orientation of the underground fractured volume, which are cost-effective and accurate.

### SUMMARY OF THE INVENTION

In an embodiment, a method of determining the physical properties of an underground fractured volume includes: injecting an electrically conductive and/or magnetically susceptible material into the underground fractured volume; transmitting electromagnetic radiation through the fractured volume, wherein the electrically conductive and/or magnetically susceptible material disposed in the underground fractured volume promotes increased conductivity of the electromagnetic radiation; measuring the transmitted electromagnetic radiation using one or more receivers; and determining physical properties of the underground fractured volume based on changes in the electromagnetic radiation passing through the underground fractured volume. The underground fractured volume may be produced using a hydraulic fracturing process. In some embodiments, the underground fractured volume surrounds a horizontal well, with the underground fractured volume being perpendicular or at some angle to the direction of minimum principal stress of the horizontal well. In other embodiments, the underground fractured volume surrounds a vertical well, with the underground fractured volume being perpendicular to the direction of the minimum principal stress of the vertical well.

If an electrically conductive material is used, the material may have a resistivity of between about 0.001 ohm-m to about 1 ohm-m. In some embodiments, the material is calcined petroleum coke, silica sand coated with a highly conductive coating, or a ceramic particle with a coating that has a high electrical conductivity or high magnetic susceptibility.

In an embodiment, transmitting electromagnetic radiation through the underground fractured volume includes: placing one or more electromagnetic transmitters in, above or proximate to a borehole extending into the underground fractured volume; placing one or more electromagnetic receivers in, above or proximate to a borehole extending into the underground fractured volume, wherein one or more of the receivers are placed at a predetermined distance from the transmitters; and activating one or more of the transmitters to produce electromagnetic radiation that pass through the underground fractured volume. In an embodiment, transmitting electromagnetic radiation through the fracture is accomplished with the use of a probe. A probe may include an elongated substrate; one or more transmitters coupled to the elongated substrate; and one or more receivers coupled to the elongated substrate. One or more of the receivers are placed at a predetermined distance from the transmitters.

In an embodiment, determining the physical properties of the fracture comprises comparing the measured electromagnetic radiation to simulated electromagnetic communication patterns. Analysis of the received electromagnetic radiation may allow the length, height and orientation of the underground fractured volume to be determined The analysis may allow a computer model of the underground fractured volume created, which can be used to assist in the optimization of the fluid extraction process.

In an embodiment, a method of extracting fluids from an underground fractured volume includes: injecting an electrically conductive and/or magnetically susceptible material into a borehole at a pressure sufficient to produce an underground fractured volume; and recovering fluids from the underground fractured volume.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Described herein is a method for the analysis of an underground fractured volume by the use of electromagnetic transmitters and receivers in or near a borehole and electrically conductive proppant. Injecting an electrically conductive and/or magnetically susceptible material into an underground fractured volume transforms the fractures into highly conductive (or magnetically susceptible) sheets in a rock medium of relatively low electrical conductivity (and magnetic susceptibility). The highly conductive (susceptible) fractures can be electromagnetically differentiated from the background rock matrix due to the large electrical conductivity or magnetic susceptibility difference. The underground fractured volume can be excited through electromagnetic radiation by use of one or more electromagnetic radiation transmitters in, above or immediately outside the borehole. One or more electromagnetic receiving receivers in, above or immediately outside the borehole then receive the electromagnetic radiation and compute propped fracture dimensions.

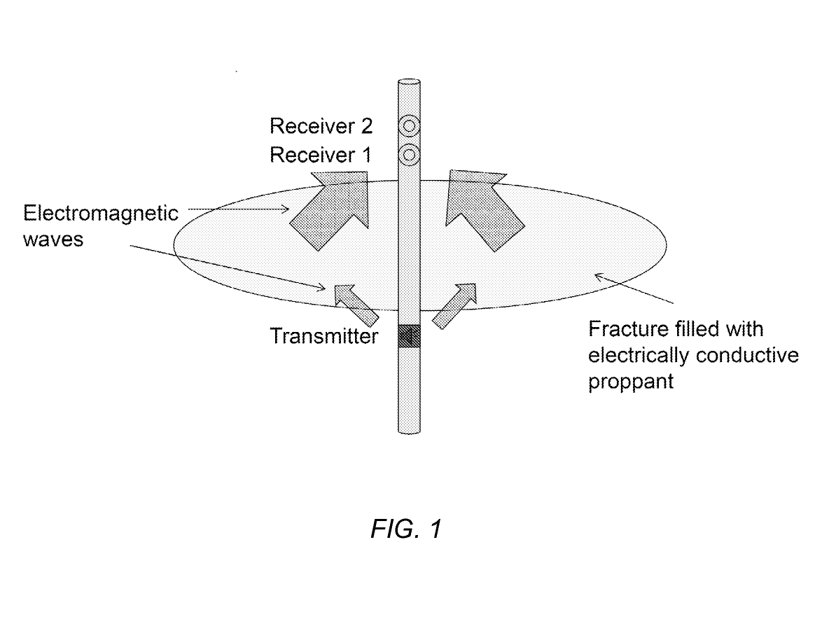

FIG. 1 depicts a schematic diagram of this process. An underground fractured volume (denoted as the yellow shaded area) is filled with an electrically conductive proppant. Electromagnetic radiation is sent into the underground fractured volume from one or more transmitters. The electromagnetic radiation passes through the fractured volume and is collected by one or more receivers. The electromagnetic radiation is modified by an electrically conductive and/or magnetically susceptible material. The detected modified electromagnetic radiation is used to determine physical properties of the underground fractured volume. Physical properties that may be determined include the propped length, height, width, orientation, azimuth and dip.

The transmitter/receiver structure, the borehole and the communication between transmitters and receivers have been simulated. Using principles of electromagnetism to analyze the simulated communication patterns between the transmitters and receivers, the length, height and orientation of an underground fractured volume can be determined. Because this invention can estimate the length, height and orientation of an underground fractured volume it can be a very useful method for fracture diagnostics.

The use of electromagnetics in underground fractured volume diagnostics is unusual and differs from the current technologies, which use principles from acoustics and chemical tracers to perform fracture diagnostics. In addition, creating a highly electrically conductive (or magnetically susceptible) fracture by injecting an electrically conductive and/or magnetically susceptible material into an underground fractured volume is novel since current practices only inject non-conductive proppants into fractures.

The advantages of this method are numerous. First, the method can reduce the amount of equipment required to perform fracture diagnostics as compared to the currently used technology of microseismic monitoring, which requires down-hole geophones and surface monitoring equipment. The method can also eliminate the need of a secondary monitoring well that is used in many current technologies of fracture monitoring. The method is potentially more economical to implement due to less equipment requirements and the fact that it does not require a secondary monitoring well. Furthermore, the method should be more accurate at determining hydraulic fracture geometry than currently used methods.

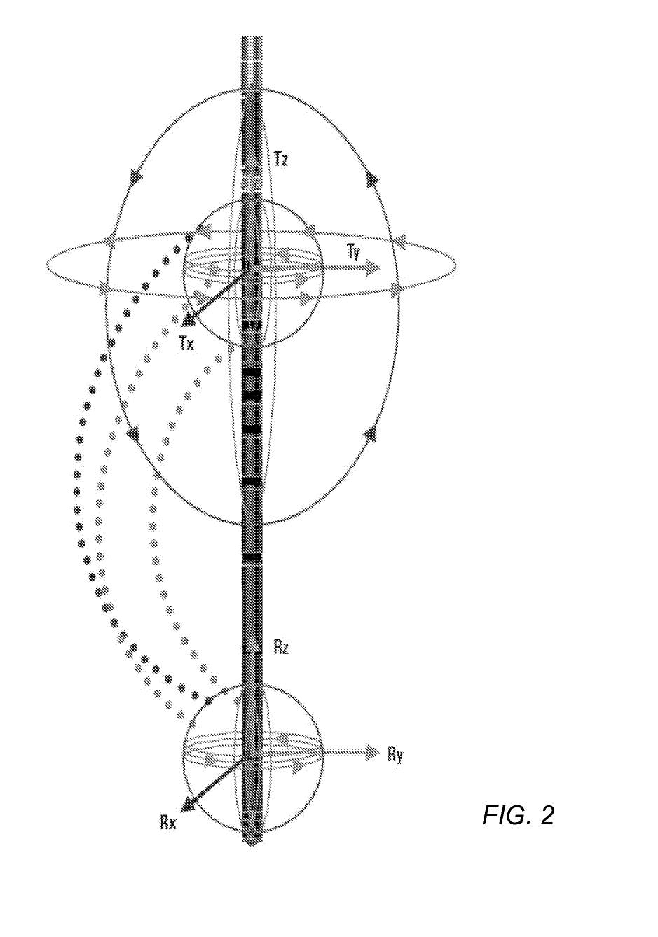

In an embodiment, low frequency electromagnetic induction may be used to generate electromagnetic fields in an underground fractured volume. Induction is the phenomena of inducing a current in a conductor by changing the magnetic field near the volume. In an embodiment, a current can be induced in the electrically conductive and/or magnetically susceptible material by the use of magnetic fields. An embodiment of a probe that may be used to induce currents in a formation is depicted in FIG. 2. The probe in FIG. 2 includes a tridirectional transmitter having transmission axis of Tₓ, T_{y} and T_{z}. The probe also includes three tridirectional receivers having receiving axis of Rₓ, R_{y}, and R_{z}. In an embodiment, the receivers are placed at various predetermined distances from the transmitter. The distance from the transmitters to the receivers may be placed at a short spacing (1 ft. to 15 ft.), a medium spacing (15 ft. to 45 ft.) or a long spacing (45 ft. to 100 ft) from the transmitter. In a specific embodiment, the transmitters and receivers are coupled to an elongated support having a diameter of about 1 in. to about 5 in. (e.g., 3.625 inches) The transmitter may generate a vertical magnetic dipole of between about 100 A−m to about 5000 A−m (e.g., 1000 A−m). The frequency of operation may range from about 10 Hz to about 10000 Hz (e.g., 100 Hz). The probe may be configured to fit within a borehole extending into the underground fractured volume.

A simulation model was used to analyze the theoretical fractured volumes having various propped lengths and being oriented in horizontal and vertical wells. Fractured volumes were analyzed perpendicular and oriented with the borehole of wither horizontal or vertical wells. Simulations were performed with and without a steel casing along the borehole wall. Uniform and non-uniform distribution of proppant was also investigated.

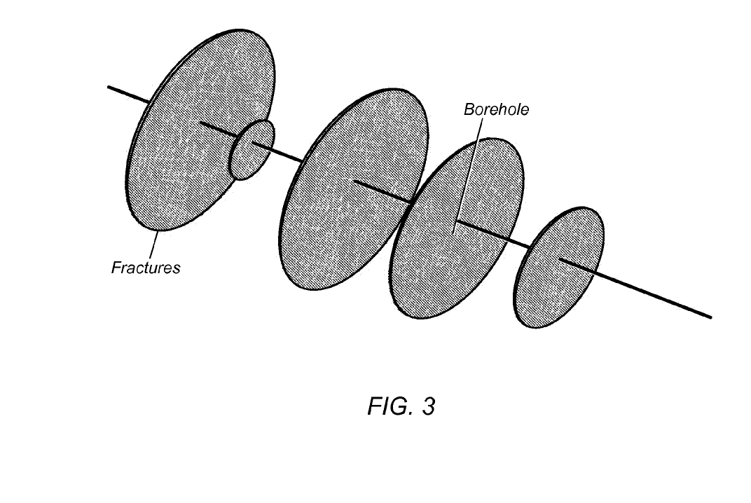

In one embodiment, the hydraulic fractures are modeled as conductive ellipsoidal disks in an explicit non-conductive borehole, as shown in FIG. 3, for ease of studying first order effects. After solving the simplest cases, more complex cases that include boreholes with steel casing can be modeled, as well as proppant banking in horizontal wells. A FEKO electromagnetic simulator may be used that solves Maxwell's equation (Eqn. 1 and Eqn.2) using Method of Moments (method of weighted residuals) in the frequency domain.

∇×E=−M−jωμH (1)

∇×H=J+jωεE (2)

where

E=Electric field [V/m]

H=Magnetic Field Intensity [A−m]

M=Magnetizing current

J=Electric current [A]

ε=Permittivity [Farads/m]

μ=Magnetic permeability [Henries/m]

The Methods of Moments (method of weighted residuals) is a method that uses the relationship:

L(f)=g

where L is a linear operator, g is a known forcing function and f is unknown. In electromagnetic problems, L is an integro-differential operator, f is the unknown function (charge, current) and g is a known excitation source.

$$f = {\sum }_{n = 1}^{N} {a}_{n} {f}_{n}$$

$$R = g - {\sum }_{n = 1}^{N} {a}_{n} L ( {f}_{n} )$$

Frequency independent dielectric modeling is based on the relationship:

$${ɛ}_{eff} = {ɛ}_{0} {ɛ}_{r} - j \frac{σ}{ω}$$

Magnetic modeling is frequency independent and can be modeled according to:

μ_{eff}=μ₀μᵣ(1−j tan δ_{μ})

The following assumptions were made in the model:

Fractures are modeled as ellipsoidal discs in the rock formation matrix

Borehole is explicitly modeled (cased or open-hole)

Steel casing is used.

Minimum spacing between fractures is more than maximum spacing between transmitter and receiver (i.e. minimum fracture spacing is 60 feet).

Proppant distribution is considered to be uniform. However, cases mimicking non-uniform distribution have been studied.

Bucking coil has been incorporated in the model to cancel out direct coupling between transmitter and receiver.

In the simulations a low frequency electromagnetic induction (“LFEMI”) probe with one triaxial transmitter and three triaxial and receiver sets spaced at 6 ft, 30 ft and 60 ft respectively was used. Induction coils were modeled as vertical magnetic dipoles (“VMDs”) and horizontal magnetic dipoles (“HMD”) of 1000 A−m operating at frequency of 100 Hz. Bucking coils to cancel out direct transmitter to receiver coupling (primary field) were also modeled. The bucking coils allow us to observe only the secondary field that contains information about the conductivity and geometry of anomalies in the formation matrix. Distinct cases were simulated for fracture half-lengths of 30 m, 50 m, 75 m and 100 m for the moving LFEMI probe. Also, the dip was varied from perpendicular to borehole up to 45 degrees with respect to the longitudinal axis of the borehole, in increments of 15 degrees. This dip was employed for both horizontal and vertical wells. Table 1 lists the parameters used in the following simulations.

| Parameter | Value | |
|---|---|---|
| Matrix | 5 | Ohm-m |
| Proppant | 0.001 | Ohm-m |
| Steel casing | 7 × 10⁻⁷ | Ohm-m |
| Strength of VMD | 1000 | A-m |
| Frequency of operation | 100 | Hz |

Case 1—Perpendicular Fracture in a Horizontal Well

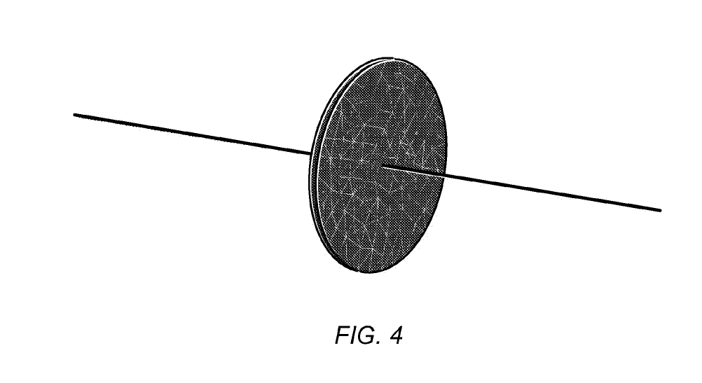

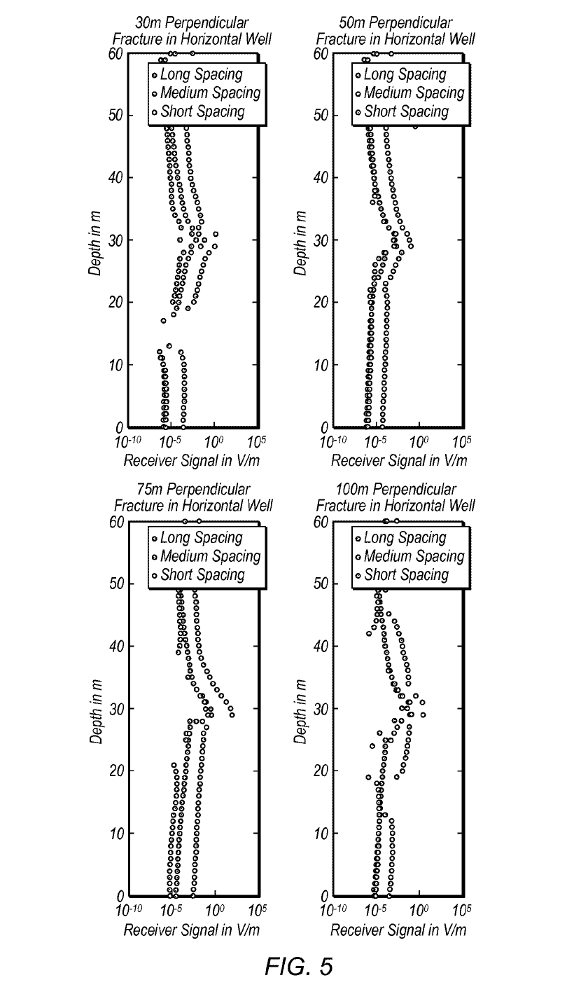

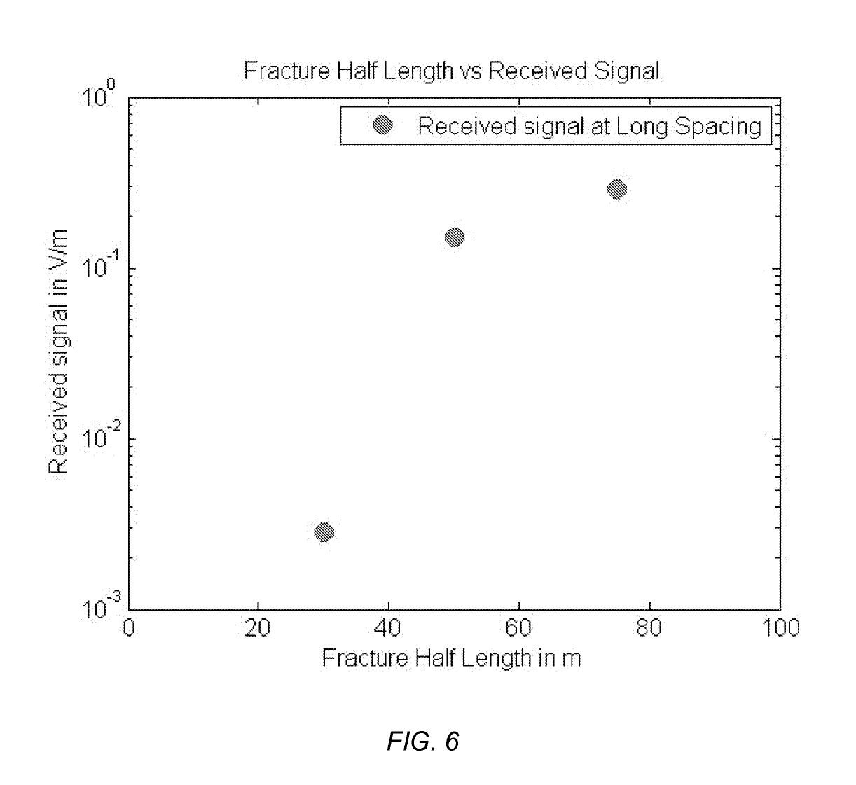

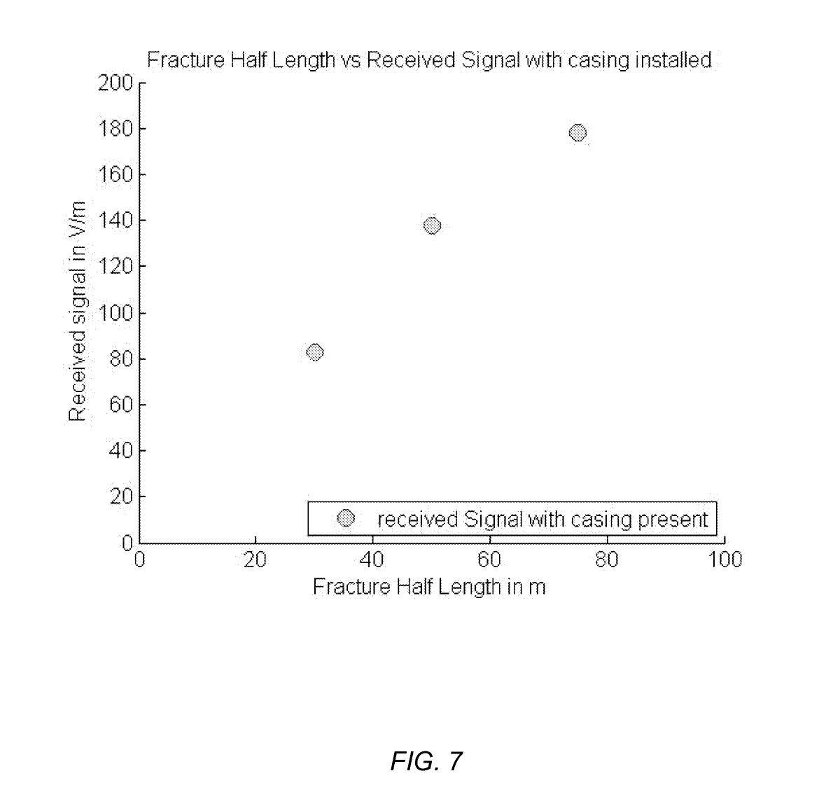

A schematic diagram of a perpendicular fractured volume in a horizontal well is shown in FIG. 4. In this case, perpendicular penny-shaped fractures were modeled which show an increase in received signal as the fracture half-length is increased. However, as the half-length is increased beyond 100 m, the received signal gets progressively noisier than what can be distinguished effectively. FIG. 5 plots fracture half-length against the amplitude of the received signal. In FIG. 5, the fracture is placed at 30 m and the plot is of the moving tool response. It was noted that the long spacing receiver is most sensitive to a unidirectional increase in half-length of fractures. FIG. 6 depicts the fracture length vs. received signal when no casing is present. FIG. 6 shows that the received signal increases with increasing fracture length. FIG. 7 depicts the fracture length vs. received signal in the presence of a steel casing. FIG. 7 shows that the casing introduces noise, but acts as a long electrode accentuating the signal.

Case 2: Oriented Fracture in Horizontal Well.

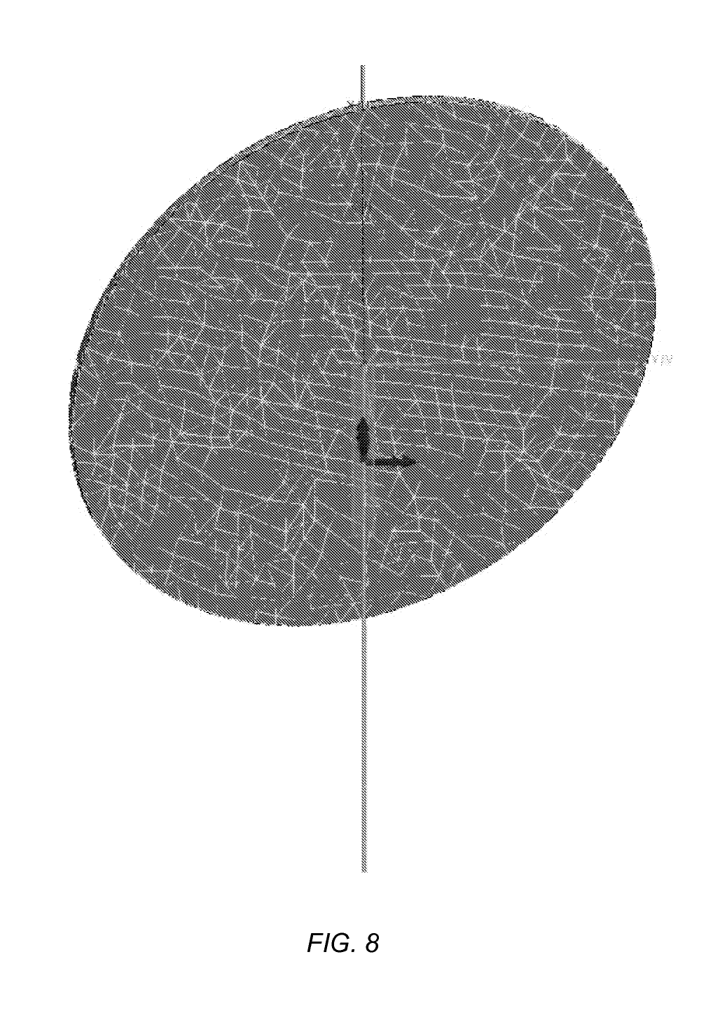

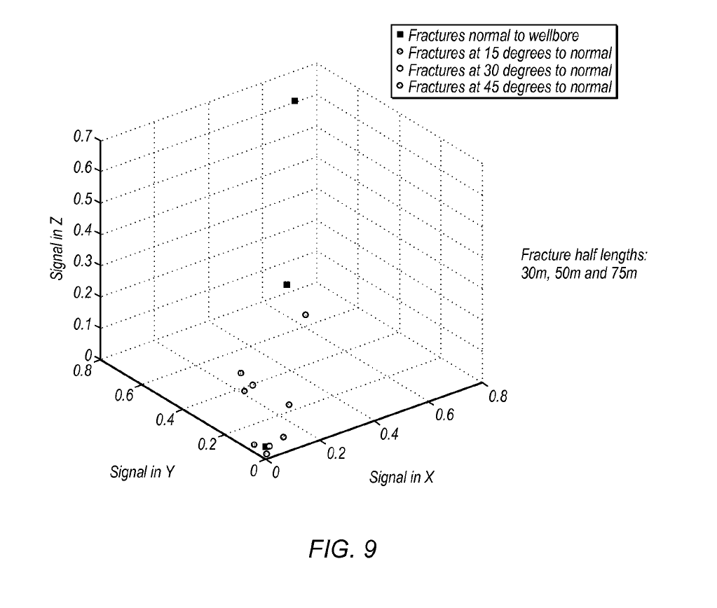

A schematic diagram of an oriented fractured volume in a horizontal well is shown in FIG. 8. FIG. 9 maps the signal received in all three different receivers in a 3D plot to diagnose the effect of orientation for different fracture length. For each angle of dip, the received signal increases monotonically with increasing fracture half-length. A distinct curve for each angle of dip can also be seen. These unique curves can be used to map the half-length, if the angle is known and vice-versa. If both are unknown, this gives a non-unique solution that would require an inversion algorithm.

Case 3: Perpendicular Fracture in Vertical Well.

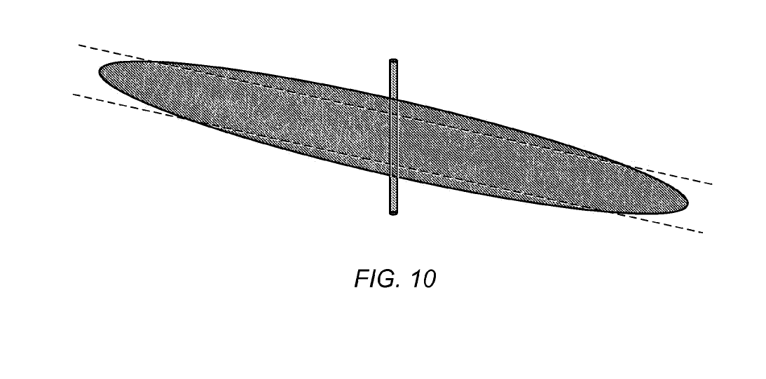

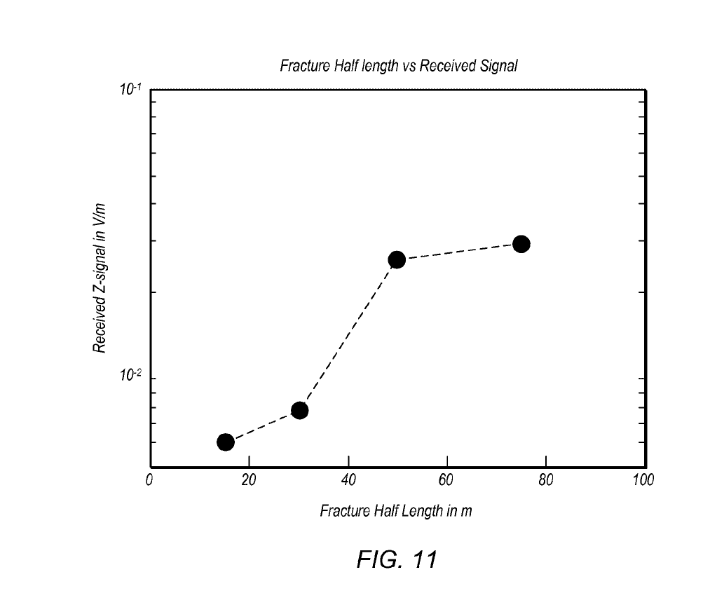

A schematic diagram of a perpendicular fractured volume in a vertical well is shown in FIG. 10. In this configuration received signal increases with increasing fracture half-length. Also for a particular orientation, signal in the direction of the axis of the receiver-transmitter is most sensitive to change in half-length as shown in FIG. 11.

Case 4: Oriented Fracture in Vertical Well.

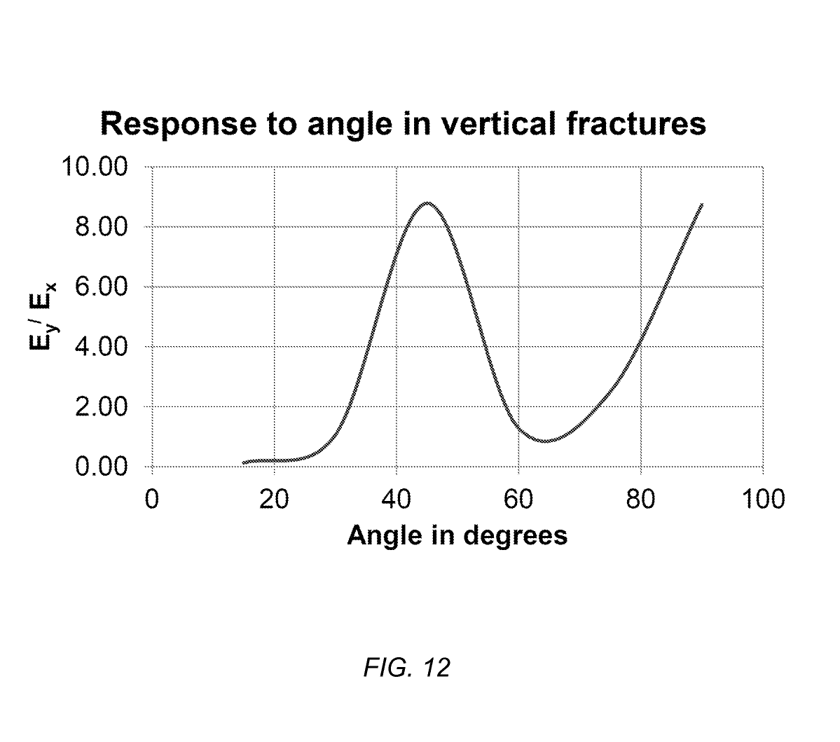

In case of varying azimuth of the vertical fracture of a given half-length, we can find the angle from the ratio of the signal in X and Y direction as shown in FIG. 12. The half-length can be independently tracked using the received signal in the Z direction.

Case 5: Proppant Distribution in Perpendicular Fracture in Horizontal Well.

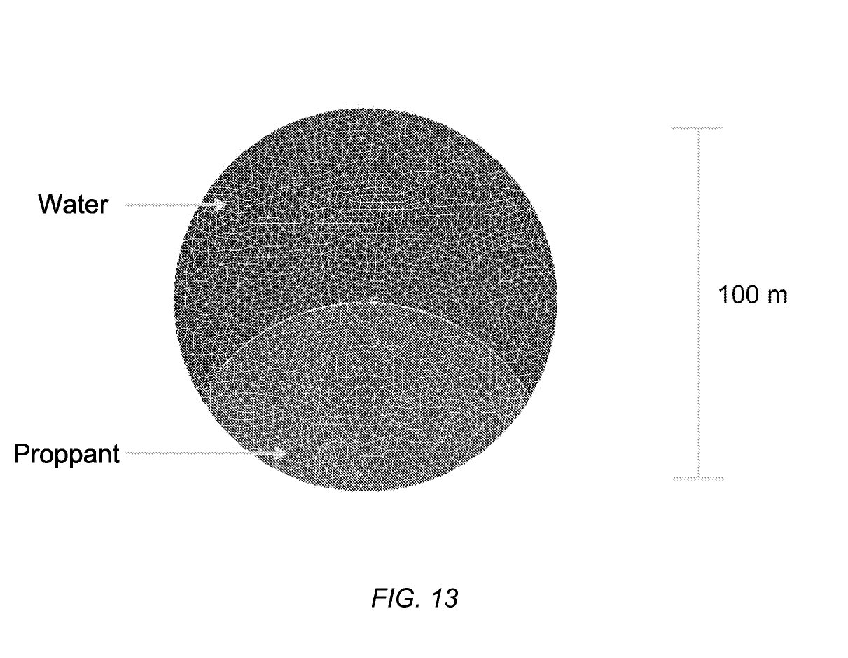

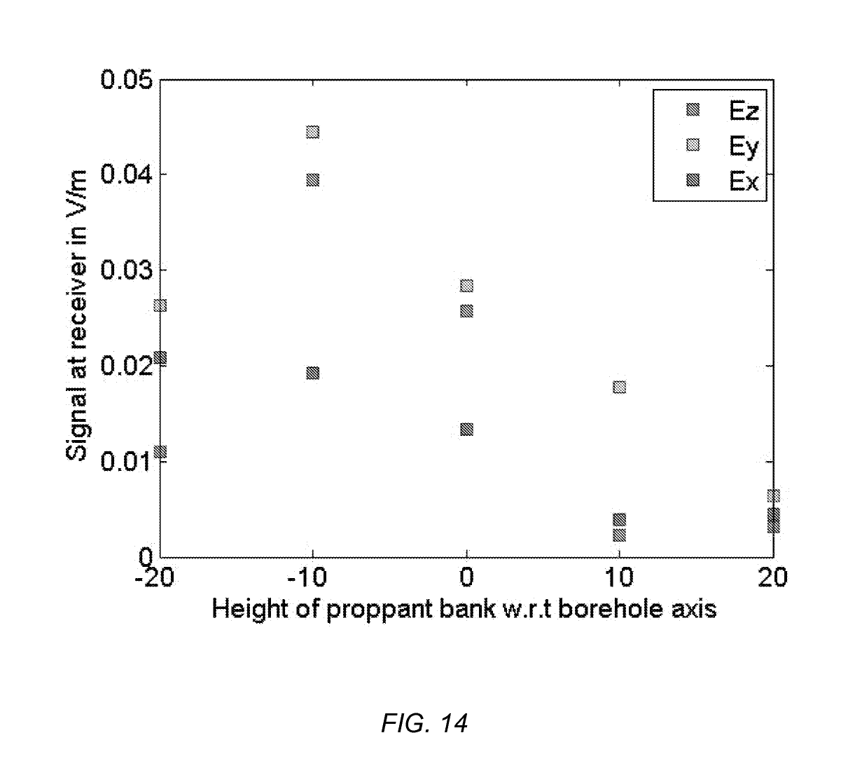

In this case we consider fractures that are partially filled with water (blue) and the rest is occupied by proppant bank (green) (See FIG. 13). FIG. 14 shows the distinct signature of each configuration. Simulations were run for different heights of proppant with respect to the borehole axis. This set of simulations shows that we can distinguish proppant distribution using LFEMI, since it is sensitive to the electrical properties of the proppant. However, proppant distribution coupled with complex geometries of the fracture can give rise to non-unique solutions of the inverse problem.

Case 6: Steel Casing.

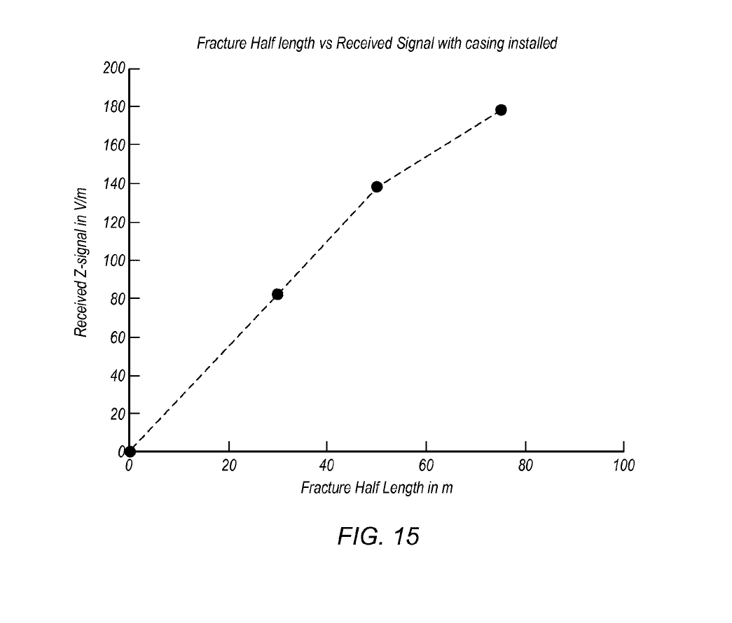

We employed steel casing in each of the above configurations. When a steel casing is present, in each of the cases, the signal is accentuated as shown in FIG. 15.

From the above simulation cases we can see that LFEMI is capable of measuring fracture propped half-length, height, width, dip, azimuth as well as detect proppant distribution. This technique is independent of any fracture/ reservoir/ geomechanical model and directly measures the location of the proppant in the fracture.

Sensitivity Analysis

We have run the following sensitivity analysis to determine the best conditions to use LFEMI for fracture diagnostics. The following factors were investigated to determine the sensitivity of the LFEMI technique:

Frequency of Operation

Spacing of Transmitter and Receiver

Resistivity of Matrix

Proppant Distribution

Resistivity of Proppant

Magnetic Permeability of Proppant

For each case, we have kept all other factors constant, while changing the one under investigation.

Frequency of Operation.

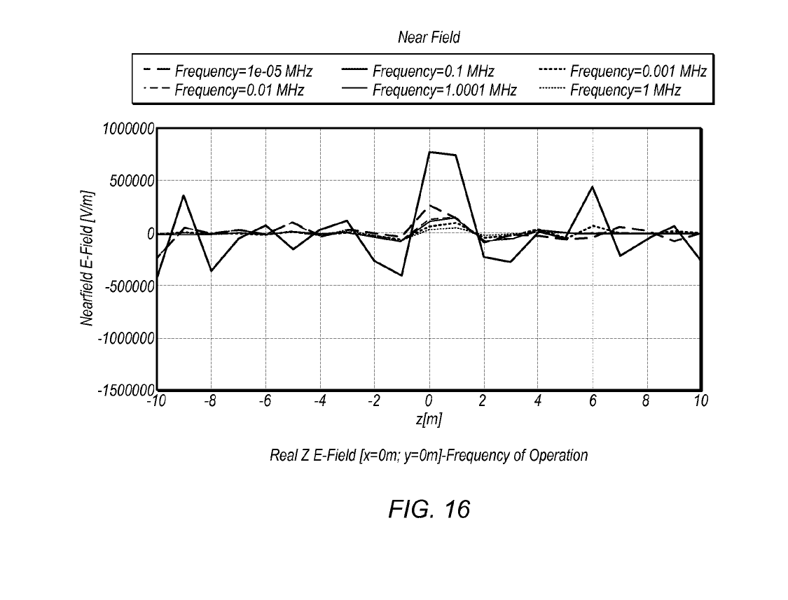

The frequency of operation was changed from 10 Hz to 1 MHz in logarithmic increments of 10. As shown in FIG. 16, the best signal is received for a frequency of 100 Hz.

Spacing of Transmitter-Receiver.

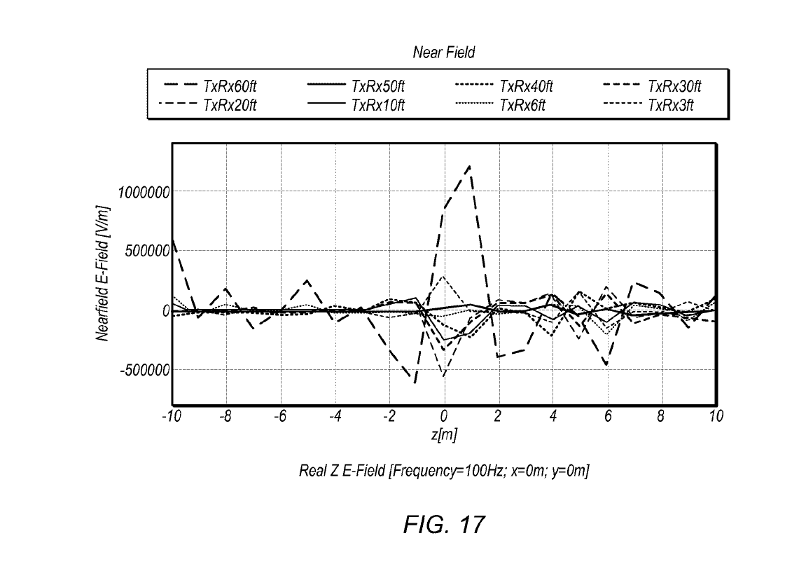

8 different cases of transmitter-receiver spacing were simulated as shown in FIG. 17. As seen in FIG. 17, the 60 ft spacing has the highest response at the fracture but is also fairly noisy. The shorter spacing, however, is most sensitive to the location of the fracture in the borehole. Therefore it is preferable to use both the short and long spacing to find the location and the dimension of the fracture. Readings from all three receiver arrays can be combined to find the exact location of the fracture and dimension.

Resistivity of Matrix.

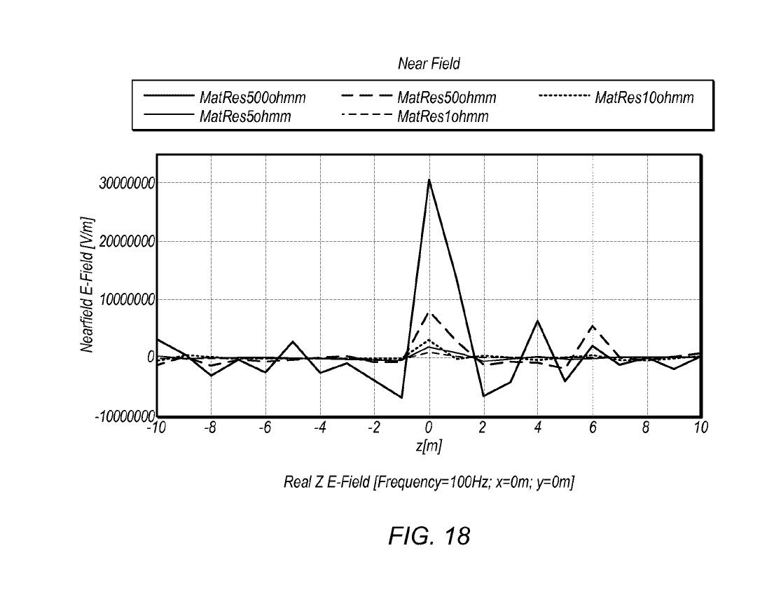

The resistivity of the matrix was changed (from 1 ohm-m to 500 ohm-m) while keeping all other parameters the same. FIG. 18 shows that increasing the matrix resistivity increases the received signal, which implies that having a higher matrix resistivity would also increase the depth of investigation. This also shows that the method will not lose its functionality within this range of matrix resistivity.

Resistivity of the Proppant.

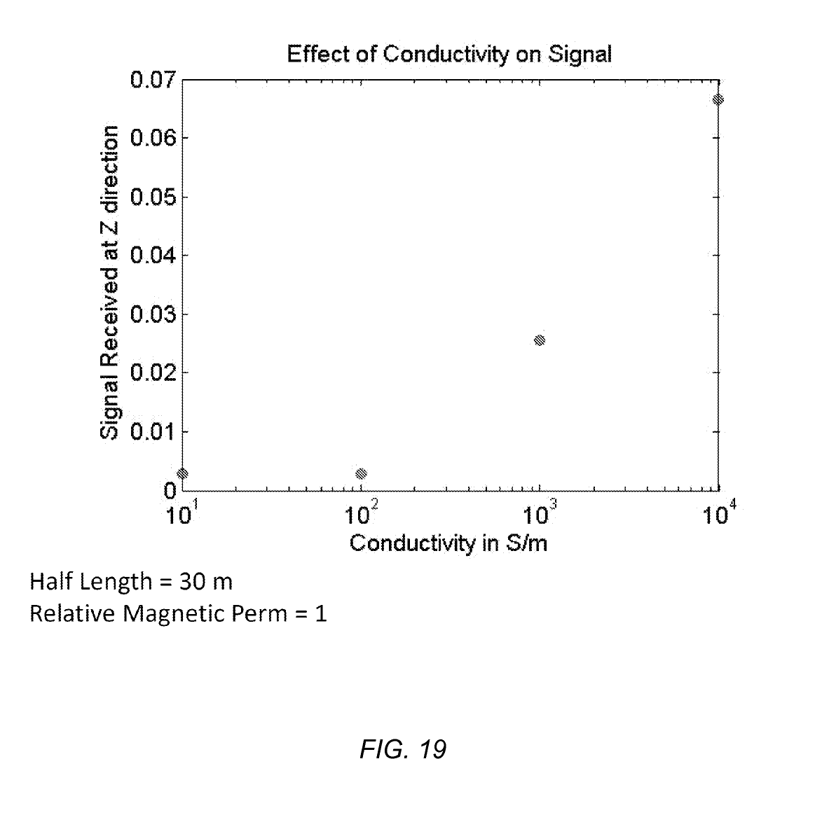

FIG. 19 shows the effect of a change in the resistivity of the proppant on signal strength. FIG. 19 shows that the lower the resistivity of the proppant up to 0.001 ohm-m (which increases the contrast of resistivity with matrix), we get a higher signal. However, if we decrease the resistivity beyond that, the received signal decomposes. Also increasing the resistivity beyond 1 ohm-m makes the overall signal so noisy that it is difficult to detect the hydraulic fracture.

### CONCLUSION

A low frequency induction logging tool can be used to detect hydraulic fractures propped with electrically conductive or magnetically susceptible proppants. Using realistic parameters to simulate the geology, proppant, and the probe we were able to obtain a depth of investigation of 250 feet. Sensitivity analysis confirms an ideal frequency of operation (100 Hz), transmitter-receiver spacing (60 ft) and the resistivity of the environments (1 ohm-m to 500 ohm-m) for this particular simulation. It should be understood that other frequencies and transmitted-receiver spacings can be used for different underground fractured volumes.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of determining the physical properties of an underground fractured volume comprising:
injecting an electrically conductive and/or magnetically susceptible material into the underground fractured volume;
transmitting electromagnetic radiation through the underground fractured volume, wherein the electrically conductive and/or magnetically susceptible material disposed in the underground fractured volume promotes increased conductivity of the electromagnetic radiation, wherein the frequency of the electromagnetic radiation is between about 10 Hz to about 10,000 Hz;
measuring the transmitted electromagnetic radiation using one or more receivers; and
determining physical properties of the underground fractured volume based on changes in the electromagnetic radiation passing through the underground fractured volume.

2. The method of claim 1, wherein the material is an electrically conductive material.

3. The method of claim 1, wherein the material is a magnetically susceptible material.

4. The method of claim 1, wherein the material is a liquid solution.

5. The method of claim 1, wherein the injected material changes phase from a liquid to a solid or a liquid to a gas.

6. The method of claim 1, wherein the material is a solid material.

7. The method of claim 1, wherein the material is a proppant.

8. The method of claim 1, wherein the underground fractured volume is produced by a hydraulic fracturing process.

9. The method of claim 1, wherein the underground fractured volume surrounds a horizontal well, with the underground fractured volume being perpendicular or at some angle to a borehole of the horizontal well.

10. The method of claim 1, wherein the underground fractured volume surrounds a vertical well, with the underground fractured volume being perpendicular or at some angle to a borehole of the vertical well.

11. The method of claim 1, wherein the material is an electrically conductive material having a resistivity of between about 0.001 ohm-m to about 1 ohm-m.

12. The method of claim 1, wherein the material is calcined petroleum coke.

13. The method of claim 1, wherein transmitting electromagnetic radiation through the underground fractured volume comprises:
placing one or more electromagnetic transmitters in, above or proximate to a borehole extending into the underground fractured volume;
placing one or more electromagnetic receivers in, above or proximate to a borehole extending into the underground fractured volume, wherein one or more of the receivers are placed at a predetermined distance from the transmitters; and
activating one or more of the transmitters to produce electromagnetic radiation that pass through the underground fractured volume.

14. The method of claim 1, wherein the underground fractured volume surrounds a borehole of a well, and wherein transmitting electromagnetic radiation through the fracture comprises:
placing a probe into the borehole, wherein the probe comprises: an elongated substrate; one or more transmitters coupled to the elongated substrate; and one or more receivers coupled to the elongated substrate, wherein one or more of the receivers are placed at a predetermined distance from the transmitters; and
activating one or more of the transmitters to produce electromagnetic radiation that pass through the underground fractured volume.

15. The method of claim 14, further comprising moving the probe through the borehole while transmitting electromagnetic radiation from the one or more transmitters; and measuring the transmitted electromagnetic radiation using one or more receivers as the probe is moved through the borehole.

16. The method of claim 1, wherein determining the physical properties of the underground fractured volume comprises determining the length, height and orientation of the underground fractured volume.

17. The method of claim 1, wherein determining the physical properties of the underground fractured volume comprises comparing the measured electromagnetic radiation to simulated electromagnetic communication patterns.

18. A computer model of an underground fractured volume prepared by the method of claim 1.

19. (canceled)

20. A method of extracting fluids from an underground fractured volume comprising:
injecting an electrically conductive and/or magnetically susceptible material into a borehole at a pressure sufficient to produce an underground fractured volume;
transmitting electromagnetic radiation through the underground fractured volume, wherein the electrically conductive and/or magnetically susceptible material disposed in the underground fractured volume promotes increased conductivity of the electromagnetic radiation, wherein the frequency of the electromagnetic radiation is between about 10 Hz to about 10,000 Hz;
measuring the transmitted electromagnetic radiation using one or more receivers;
determining physical properties of the underground fractured volume based on changes in the electromagnetic radiation passing through the underground fractured volume; and
recovering fluids from the underground fractured volume.
